(19) United States
(12) Patent Application Publication
(10) Pub. No.: US 2011/0135874 A1
(43) Pub. Date: Jun. 9, 2011

(54) EDGE PROTECTOR

(75) Inventor: Patrick Petrus Antonius Maria Van Berlo, Cambridge (NZ)

(73) Assignee: CORCEL IP LIMITED, HAMILTON (NZ)

(21) Appl. No.: 12/999,609

(22) PCT Filed: Jun. 25, 2009
(86) PCT No.: PCT/NZ09/00122

§ 371 Date: Feb. 25, 2011

(30) Foreign Application Priority Data
Jun. 26, 2008 (NZ) 569462
May 25, 2009 (NZ) 577254

(51) Int. Cl. B32B 3/04; B32B 38/04; B32B 38/10; B32B 37/12

(52) U.S. Cl. 428/121; 156/200; 156/465

(57) ABSTRACT

The present invention relates to a method of forming an edge protector from a panel, including the steps of a) forming a channel in the panel; b) applying adhesive into the channel; c) folding the panel to close the channel; and d) holding the channel closed until the adhesive has formed a bond.

### TECHNICAL FIELD

The present invention relates to an improved edge protector.

### BACKGROUND ART

The use of protectors to protect the edges of articles during storage and transport is well known. In one form an edge protector can be formed by laminating sheets of paper together, or by layering a single sheet upon itself, to form a rigid board which can be bent into a suitable shape. The shape may be formed typically by passing the laminated paper board (whilst still wet with adhesive) through a rolling process whereby the angle is progressively increased until the planar board is bent into the desired shape, commonly so that the interior angle is substantially 90°.

One problem with this method is that it takes a significant amount of paper and adhesive to form the laminated board used in the edge protector, thereby increasing the cost of the edge protector. The resultant edge protector (or corner board), tends to be relatively heavy, which may add to shipping costs especially when used to protect the edges of articles during air freight.

A solid laminated paper edge protector may also provide limited cushioning against impact, such as can occur during transport and which can result in damage to the article to which the protector is covering.

Both of these problems may be overcome to some extent by forming the edge protector from corrugated (or honeycomb) paper board. One common form of edge protector involves wrapping a sheet of single or double face corrugated paper around the edge. This can easily be achieved by aligning the flutes (i.e. corrugations) with the edge to be protected, so that the corrugated paper can be bent around the edge. Such edge protectors can provide improved cushioning, as the flutes absorb impact when compressed, as well as significantly reducing the density (and therefore weight) of an edge protector in comparison with an edge protector made from laminated paper board.

However, one problem with single face corrugated paper edge protectors is that the folded sheets typically need to be fixed in place around an edge, for example by taping or stapling, in order to hold the sheet against the article. Further, a heavy blow, such as can be experienced during transport, can easily crush the flutes and result in damage to the article.

This problem, has been addressed in edge protectors in which a sheet of single face corrugating paper is folded and glued to form a multilayer edge protector. An example of one such configuration is disclosed in U.S. Pat. No. 7,229,924. Such multilayer edge protectors may provide improved cushioning over a single face folded corrugated sheet, but this can still be insufficient to protect an edge from damage during handling and transport.

It is well known that the impact resistance can be increased substantially by aligning the flutes so that they are orientated substantially at 90° to the plane of the face sheet or liner of a corrugated board. A double face corrugated board can be formed in which the flutes are sandwiched between two planar liner sheets, such that the orientation of the flutes is normal to the plane of the liners. In other words, if such a double face corrugated board is made flat, so that the liners are horizontal, then the flutes are aligned vertically. Such corrugated boards may be referred to as vertically fluted double face boards.

A vertically fluted double faced board is known to have significantly higher impact resistance than a double face corrugated board in which the flutes are aligned substantially parallel (i.e. horizontally) to the liners.

However, the inherent rigidity of a vertically fluted double face corrugated board means that it cannot be folded or bent to form an edge protector in the way that a horizontally fluted double face corrugated board can be. For example, in a horizontally fluted double faced corrugated board it is generally sufficient to scour the surface of one liner to enable it to be folded about the scoured line. The same is not true of a vertically fluted double faced corrugated board as the bending is resisted by the vertically orientated flutes.

U.S. Pat. No. 6,007,469 discloses a method for forming a honeycomb corner protector using self locking panels. In this instance the honeycomb board is a vertically fluted double face corrugated board as described above, and therefore potentially will provide superior cushioning with respect to the other types of edge protectors described above.

The edge protector disclosed in U.S. Pat. No. 6,007,469 is formed from two vertically fluted double face panels which are separated by a channel about which the panels are foldable. The two panels are connected together by a liner on an exterior side.

One of the panels includes a lip extending on an interior side over part of the channel, the lip formed from an interior liner. The lip is configured to engage a slit formed in the interior liner of the other panel so as to connect the two panels together when in the folded position.

An edge protector formed in this manner has a number of disadvantages including the relative complexity of forming and assembling the edge protector. For example, one method of forming the edge protector from a standard vertically fluted double faced board requires removal of a strip of liner and all of the underlying fluted material in order to form a channel. This can involve making a pair of parallel cuts through the interior liner and through the underlying fluted core to the other (exterior) liner to form the inner side walls of the channel. A third cut is made parallel to a side of the channel to form a slit through the interior liner in preparation for engagement of the lip.

A scraper can be used to remove the fluted material within the channel. Removal of all the fluted material from the channel may be difficult as the fluted core is typically glued to the exterior liner at the base of the channel. It is suggested that removal of the fluted material can be assisted by forming the board such that no adhesive is applied to the exterior liner in the region where the channel is to be formed. However, this can involve additional cost as it requires modification to the machine making the vertically fluted double face board.

Furthermore, a lip needs to be formed on one side of the channel. It is suggested that this can be achieved by pushing inwards the fluted material on the side wall of the channel opposite that containing the additional slit. However, in practice both ends of each flute are glued to the liners, making it difficult to form a clean lip.

A further problem is that the interior liner must be formed from rigid material in order for the lip to have sufficient rigidity to engage in the slot when the two sides are folded to form the edge protector. Generally this may require that a rigid sheet, such as cardboard, must be used, rather than a sheet of Kraft paper as is commonly used to form double face boards. This adds to the cost of the edge protector as well as increasing the weight.

Another method of forming an edge protector according to U.S. Pat. No. 6,007,469 is to form the panel initially by securing two core portions onto a single external face sheet in such a manner as to form an open channel between them. The interior face sheets can then be applied to complete the panel, including provision of a lip extending from one panel into the interior of the channel.

This process, while simpler in principle than that described above in which material is removed from a preformed board, nevertheless requires a special machine to form the panels in the required relationship which can add to the cost of production of the edge protector.

Difficulty may also be encountered when inserting the lip into the slot when forming the edge protector. Not only does this require that the lip be rigid, thus typically requiring more material, but insertion of the lip into the slit may be difficult, particularly as the length of the lip and slit increases.

Furthermore, the nature of the motion to bring the edge protector together places a limitation on the amount that the lip can protrude from the side of the channel and hence into the slit. This limitation in the depth of the lip means that the lip can very easily disengage from the slit, thus undoing the edge protector.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a method of forming an edge protector from a panel, including the steps of:
a) forming a channel in the panel;
b) applying adhesive into the channel;
c) folding the panel to close the channel; and
d) holding the channel closed until the adhesive has formed a bond.

According to another aspect of the present invention there is a method of forming an edge protector substantially as described above including the further step of:
e) cutting the panel to length prior to folding.

According to another aspect of the present invention there is provided a machine for producing an edge protector from a panel, including:
a channel former configured to form a channel in the panel;
an adhesive applicator configured to apply adhesive into the channel;
a folding mechanism; and
a receptacle;
   characterised in that
the folding mechanism is configured to fold the panel so as to close the channel and form the edge protector, and the receptacle is configured to hold the edge protector in shape until the adhesive forms a bond.

According to a further aspect of the present invention there is provided an edge protector manufactured by the aforementioned machine and/or method.

An edge protector according to the present invention is formed by first forming a channel along (or across) a panel. The channel divides the panel into a first side panel on one side of the channel and a second side panel on the other side of the channel, the surfaces of the side panels being substantially planar.

Typically the dimensions of the first side panel are substantially the same as the dimensions of the second side panel, i.e., the channel bisects the panel. Reference will be made throughout this specification to an edge protector having two equal sized side panels. However, those skilled in the art will appreciate that an edge protector may be formed having different sized side panels, and reference to an edge protector having equal sized panels only should not be considered limiting.

Adhesive is applied into the channel followed by folding the first and second side panels so as to close the channel thus enabling the adhesive to form a bond.

Once folded the first and second side panels of the edge protector define an interior angle, α, where 0°<α<180°, where they meet. In most common edge protectors a is about 90°.

In a preferred embodiment the panel is formed from double face corrugated board having a corrugated (fluted) core sandwiched between an interior face liner and an exterior face liner.

The advantage of using double face corrugated board is that it is relatively light with respect to its size, and can generally be folded about a cut or channel formed in a surface of the board.

A corrugated core may consist of one or more layers of corrugated sheet material where the flutes are orientated in a plane substantially parallel to the plane of the liner sheets. A panel with such a core will be referred to as an horizontally fluted double face corrugated board.

Alternatively, a corrugated core may have flutes orientated substantially at right angles to the plane of the liner sheets. A panel with such a core will be referred to as a vertically fluted double face corrugated board.

In a preferred embodiment the panel is formed from vertically fluted double face corrugated board.

Vertically fluted double face corrugated board is preferred as it typically is considerably more rigid and has can withstand greater impact forces than horizontally fluted double face corrugated board. However, in alternative embodiments of the present invention a panel formed from horizontally fluted double face corrugated board may be used.

In a preferred embodiment the channel is configured with a V-shaped section, having a first side and a second side meeting along a line.

A channel having a V-shaped section is preferred as it is generally simple to fold the sections of the panel on either side of the channel together so as to bring the first and second sides of the channel together to form a mitre joint.

Furthermore, a range of edge protectors may be formed by varying the angle between the first side and the second side of the channel.

In a preferred embodiment the channel extends from the interior face liner substantially to, but not through, the exterior face liner.

The depth of such a channel at its apex is therefore comparable to but less than the thickness of the double face corrugated board. This ensures that substantially all of the fluted material in the channel is removed so that the sections of the panel on either side of the channel can be readily folded so as to bring the first side of the channel into contact with the second side of the channel, the exterior liner sheet acting as a hinge.

In one embodiment the channel former is a router having a cutting head.

A router has the advantage of being a commonplace device used to form a channel in a panel by moving it along the panel. The applicant has found that a router may form a suitable channel in vertically fluted double face board in a single action as the panel moves relative to the router. However such routers tend to create paper dust and waste material.

In a machine according to the present invention the router may be held in a fixed position and the panel moved passed the router. The router is mounted with respect to a panel moving through the machine such that the channel formed by the router extends from the interior face liner substantially to, but not through, the exterior face liner of the panel.

In one embodiment the cutting head of the router is configured to form a channel having a ‘V’-shaped section.

A further advantage of using a router is that the cutting head is typically an accessory that can be readily changed as required. By choosing an appropriate cutting head both the size and the shape of the channel formed by the router can be readily changed. This simple adjustment may save time during production when forming more than one type of edge protector—for example if changing from making edge protectors with an interior angle of 90° to those with an interior angle of 120°.

However, there are a few problems associated with routing a large “V” groove. In particular scrap material in the form of dust and other particulate matter can result from the action of the router. This can make the work area dirty and the air difficult to breath due to the dust.

Other methods may be used to form a channel, but these are generally may be more complex to set up and operate. For example, a channel may be formed by making two cuts through the core to form the first and second sides of the channel, and then using a suitably shaped wedge to remove the severed core material from between the cuts. However, this requires the use of two saws (or knives), one to make each cut, which can add to the cost of the machine.

Furthermore, the saws need to be aligned precisely in order to form the sides such that they meet along a line. This is important to ensure that the core material between the cuts comes away freely to form the channel.

Setting up and maintaining the saws in this configuration may be more time consuming than setting up a router to do the same job, thus adding to the operating cost of the machine, and hence the cost of the edge protector.

In a preferred embodiment of the present invention, the channel is formed by a combination of two processes. Preferably the channel is V shaped, but it may have other forms.

The first process is to cut the board with a cutting mechanism. A variety of cutting mechanisms can be used, but in a preferred embodiment the cutting mechanism is a very thin cutting blade—say with a thickness in the order of 0.15 mm-0.2 mm.

Preferably the depth of the cut is approximately half to three quarters of the thickness of the board. While in preferred embodiments the board is approximately 10 mm thick, the principles for cutting the V shaped channel can apply to boards of various thicknesses.

The second part of the process is to deform the board in the vicinity of the cut into the desired shaped channel. The deformation may be achieved by a variety of ways—with reference to the desired shape being a V.

For example, a V shaped former in the shape of a bar may be pushed along the cut to create the channel. Other embodiments may employ an appropriately shaped press which is pushed downwards onto the board and into the cut.

However, in preferred embodiments a wheel, configured with a wedge shape on its outer circumference, is used. This wheel can be forced into the cut to deform the board into the desired V shape channel.

While in one embodiment, only one wheel may be used, the inventor has found that two or more consecutive wheels work particularly well. For example, the first wheel may only penetrate the cut by three quarters of the depth as a consequence of the resistance to the penetration of the wheel by the paper board. A second wheel may then be forced into the full depth of the cut to complete the process.

The wheels may be made of any suitable material, for example metal, ceramic or wood. However, the applicant has found that the use of a plastics material such as UHMWPE. Teflon for the wheels is particularly suitable because Teflon wheels are self lubricating and adhesive will not stick to them.

In a preferred embodiment adhesive is applied to the first and second sides of the channel.

Adhesive could be added into the channel simply by injecting the adhesive into the space formed by the channel. However, this is likely to use more glue than is necessary and may lead to an increase in the time taken to form a bond. By coating the sides of the channel only, less adhesive may be used and a good bond formed relatively quickly. In some embodiments adhesive may be applied to one surface only.

In one embodiment, adhesive is applied in droplet form.

Applying the adhesive in droplet form may result in the use of less adhesive while still applying sufficient to the exposed edges of the flutes on each side of the channel to form a good bond when the sides are brought together. This may save on the cost of materials, as well as reducing the bonding time.

In a preferred embodiment the adhesive applicator is a wheel similar or identical to the wheels forming the channel. This preferably has a rim configured in a V-shaped section substantially complementary to the V-shaped section of the channel.

In this embodiment the applicator wheel is rotatably mounted to the machine so that the rim substantially touches the first and second sides of the channel as the panel passes. An adhesive bath may be located under the wheel such that adhesive coat onto the rim as the wheel rotates.

In a preferred embodiment the V-shaped rim of the applicator wheel includes one or more grooves or ridges.

Preferably, a spiral groove/ridge or multiple grooves/ridges adjacent to each other may be cut into, or formed about, the rim such that adjacent grooves meet along an edge. A wheel configured in this way may collect adhesive from an adhesive bath into the grooves around the rim. The adhesive may then be transferred to the sides of the channel from the grooves in discrete amounts. By choosing the size (width and depth) of the grooves the amount of adhesive transferred can be varied. In a preferred embodiment the size of the groove is such that the adhesive is transferred in the form of droplets.

Having cut a channel and applied adhesive to the sides of the channel, the next step is to fold the panel so as to bring the first side of the channel into contact with the second side of the channel so that the adhesive can form a bond. This step is achieved by the combined action of a folding mechanism and a receptacle.

In a preferred embodiment the folding mechanism includes a forming surface configured to substantially the same shape as the desired shape of the finished edge protector.

Preferably, the forming surface may include a first planar side and a second planar side, the planar sides inclined with respect to each other at the same angle as the interior angle, α, of the edge protector. The planar sides may meet at a line, although preferably the apex of the forming surface may be truncated (rounded or flattened), so that the forming surface, when pushed against a panel to form an edge protector, may contact the side faces of the panel but not protrude into the channel. Preferably, the length of forming surface at least substantially corresponds to the length of the corner board.

In a preferred embodiment the folding mechanism includes an hydraulically operated ram attached to the forming surface.

An hydraulically operated ram may be used to apply a controlled pressure to push against the sides of the panel and to move the panel into a receptacle by a preset amount. An hydraulic ram is a commonplace commercial device that is commonly used in situations where repetitive, controlled, movement is required. However, those skilled in the art will appreciate that other methods could be used to move the forming surface in the required manner, and that use of an hydraulic ram should not be seen as limiting. For example, in some embodiments an air ram or mechanical screw could be used instead of an hydraulic ram.

In operation, the forming surface of the folding mechanism is aligned with the channel (containing adhesive) in the panel and opposite the opening of the channel (ie the interior side of the panel). When activated, the folding mechanism pushes the forming surface against the interior sides of the panel and into a receptacle configured to hold the edge protector in shape until the adhesive forms a bond.

In a preferred embodiment the receptacle includes at least two opposed members, each member having an inner face, an outer face and an edge therebetween, wherein the two members are positioned such that the inner face of a first member is substantially parallel to and opposite the inner face of a second member, and at least two adjustable spacers configured to adjust the separation between the opposing members, wherein the positioning of the spacers enables a clear pathway between the inner faces of the first and second members and a substantial part of the inner faces of the first and second members form a gripping surface.

In a preferred embodiment the two opposed members are rigid planar sheets.

The opposed members may be formed from any convenient material, such as rigid plastics material, wood, sheet metal, etc.

Preferably a width of each opposed member may be slightly greater than a length of the edge protector. In this way an edge protector inserted into the receptacle may be held between the two members along its entire length.

Preferably the separation between the inner faces of the members is comparable to but less than a width of the edge protector.

An edge protector has a width determined as the distance between the outer edges of the (formed) edge protector, the outer edges being those substantially parallel to the channel. This width is significantly less than the distance between the same outer edges of the panel used to form the edge protector when laid flat.

An adjustable spacer may be any device that, when engaged with the two planar members, is configured to hold the members with respect to the spacer in a manner that enables the separation between the planar members to be adjusted.

An example of an adjustable spacer is a threaded bolt combined with locking nuts, as is well known in the art. The bolt may be attached to one planar member by inserting it through an aperture in the planar member and locking it by tightening a nut on each face (inner and outer) of the planar member. The bolt may then be passed through an aperture in the second planar member (having first engaged a further locking nut onto the bolt). Locking nuts can then be tightened to each face of the second planar member to hold it in any desired position along the length of the bolt. The separation between the two planar members may be adjusted by releasing the locking nuts on either member and moving that member to a new position along the shaft of the bolt before re-tightening the locking nuts.

It will be appreciated by those skilled in the art that a bolt and locking nut combination is just one of many types of adjustable spacer that reference to an adjustable spacer as a bolt and locking nuts in this specification should not be seen as limiting. For example, in some embodiments an air or hydraulic ram may be used to adjust the spacing between the members.

The adjustable spacers are located with respect to the members such as to leave a clear pathway for an object, in the present case a formed edge protector, to move into the receptacle, (ie, the space between the members) at one end, through the receptacle, and out of the receptacle at the other end of the members.

Preferably the spacers may be adjusted such that the separation of the inner faces of the two members is such as to hold an edge protector placed between the inner faces in a position where the channel in the edge protector is closed.

The inner face of each member form gripping surfaces used to grip and hold an object placed between them.

Preferably the gripping surface is roughened or textured.

A roughened or textured gripping surface may provide a greater friction force to hold an object against the surface and to prevent slipping.

In a preferred embodiment an edge of each member is configured to facilitate, movement of an object pushed against the edge into the receptacle.

The edge of the member that engages with the exterior side of the panel forming the edge protector may be rounded to avoid damage to the surface of the edge protector as may occur if the edge is sharp. This may also reduce wear on the edge of the members, increasing the operating lifetime of each member and thus lowering production costs.

In a preferred embodiment the edge includes a gripping surface.

A gripping surface may be used to limit slippage of the edge protector during the folding process. The inventor has found that an improved fold can be achieved by applying a small frictional force to the exterior face liner as it engages with the edge of the receptacle. This slows the motion of the edge protector into the receptacle, allowing more time to fold the sections of the panel on either side of the channel together to close the channel.

Preferably the gripping surface is a textured rubber layer, although other materials may be used to provide the same functionality.

In alternate embodiments the receptacle may be a guide, with the sides of the members being fixed in place. For example the receptacle may be in the form of an open ended rectangular tube with the members forming two opposing sides connected by side walls. The side walls may be solid or may consist of a plurality of spaced apart spacers.

When activated, the folding mechanism pushes the exterior sides of the panel against the edges of the receptacle causing the panel to fold about the channel. The separation of the inner faces of the receptacle is such that the action of the edges of the receptacle causes the channel to close, forming the desired shape of the edge protector.

Further movement of the folding mechanism may push the formed edge protector into the space between the inner faces of the receptacle. The separation of the inner faces is such that as the folding mechanism is withdrawn the edge protector is held in place by the friction exerted between the outer edges of the edge protector and the inner surfaces of the receptacle.

This process is repeated for each edge protector formed. As each additional edge protector is pushed into the receptacle it displaces the previous one further into the receptacle, so that a stack of edge protectors is formed between the gripping surfaces.

The receptacle has a length, being the distance between the opening of the member where each edge protector enters the receptacle to the opposing opening where the edge protector is ultimately pushed out of the receptacle. This length may be chosen such that each edge protector remains inside the receptacle for a sufficient period of time for the adhesive to form a bond.

The required length will depend on the production rate of edge protectors since this determines the rate at which newly formed edge protectors are pushed into the receptacle and hence the rate at which the stack moves towards the other open end of the receptacle.

One significant advantage of using a receptacle as described above is that no additional heating is required to speed up formation of the bond, thus saving energy and lowering production costs without limiting the rate of production.

The present invention provides many advantages over prior art edge protectors. These include:
Increased edge protection through production of high impact strength, lightweight edge protectors from vertically fluted double face corrugated board that can withstand significantly greater impacts than prior art edge protectors formed from horizontally fluted double face corrugated board.
Low cost production through use of a relatively simple method of forming a channel in the corrugated board, applying glue in droplet form and the use of a receptacle to hold the edge protector while the glue forms a bond without the requirement for heating.

### BRIEF DESCRIPTION OF DRAWINGS

Further aspects of the present invention will become apparent from the following description which is given by way of example only and with reference to the accompanying drawings in which:

FIG. 1 shows an edge protector according to one embodiment of the present invention;

FIG. 2A shows a step in the formation of an edge protector according to one embodiment of the present invention;

FIG. 2B shows an adhesive applicator according to one embodiment of the present invention;

FIG. 2B shows another step in the formation of an edge protector according to one embodiment of the present invention;

FIG. 3 shows a schematic side view of a machine for forming an edge protector according to one embodiment of the present invention;

FIG. 4A shows a schematic representation of a step in the formation of an edge protector according to one aspect of the present invention; and

FIG. 4B shows another schematic representation of another step in the formation of an edge protector according to one embodiment of the present invention, and

FIG. 5 is a perspective view of an alternate means by which the channel can be formed in the corner board.

### BEST MODES FOR CARRYING OUT THE INVENTION

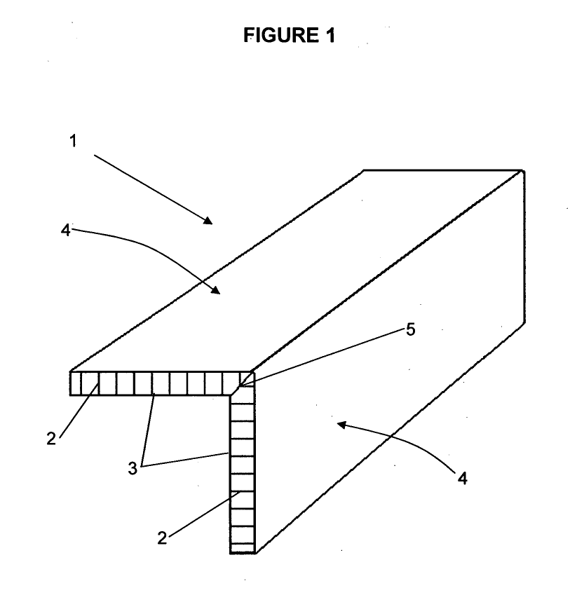

An edge protector according to one embodiment of the present invention is generally indicated by arrow (1) in FIG. 1. The edge protector (1) is formed from a panel of double face corrugated board including a core (2) of vertically orientated flutes sandwiched between an interior liner (3) and an exterior liner (4).

The two sections that form the edge protector are orientated at substantially 90° with respect to one another and are joined by a glued mitre join (5).

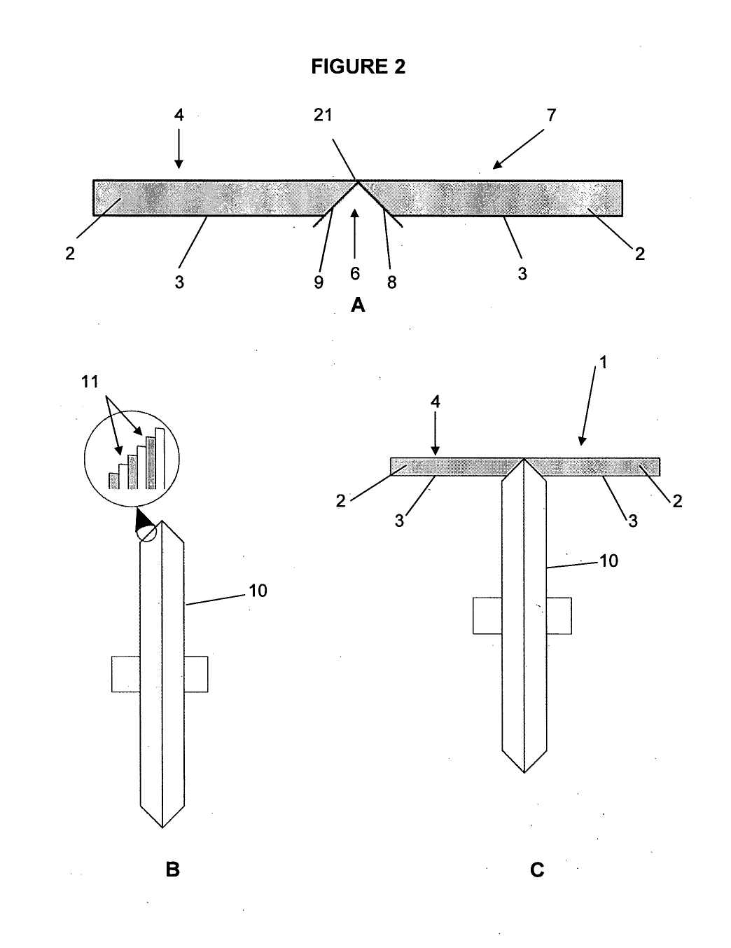

The first step in the method for forming an edge protector involves forming a channel (6) in a panel (generally indicated by arrow (7)) as shown schematically in FIG. 2A. The channel (6) is formed in a V-shape having a first side (8) and a second side (9) meeting at a line (21).

For a right angled edge protector (as indicated by (1) in FIG. 1), the angle between the first side (8) and the second side (9) of the channel (6) is substantially 90°. This angle may be varied to produce edge protectors having a range of interior angles. In general if the angle between the first side (8) and the second side (9) of the channel (6) is denoted by a, then the angle between the first side (8) and the second side (9) of the channel (6) will be substantially (180°-α).

The channel (6) extends substantially through the core (2) of the panel (7) into the vicinity of the exterior liner (4).

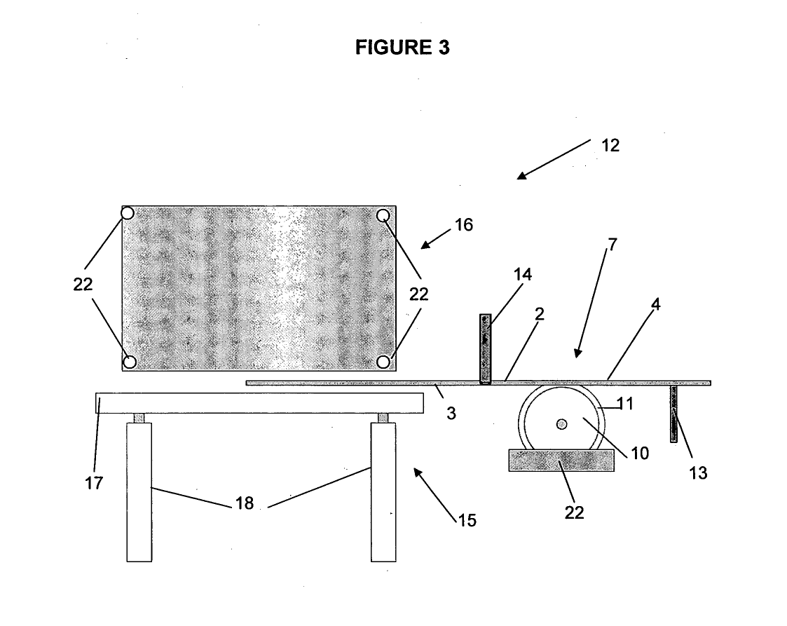

The channel (6) is formed by a router (see FIG. 3).

In step b) of the method, adhesive is applied into the channel (6) as indicated in FIG. 2C. A glue applicator in the form of a wheel (10) has a rim configured in a V-shape substantially complementary to the shape of the channel (6) so that the sides of the rim of the wheel engage with the sides (8, 9) of the channel (6).

The rim of the applicator wheel (10) is configured to include groves (11) as indicated in FIG. 2B. The grooves are configured to transfer adhesive from the grooves (11) onto the sides (8, 9) of the channel (6) in the form of droplets.

In step c) the sides of the panel are folded about the line (21) at the apex of the V-shaped channel (6), so that the first side (8) is brought into contact with the second side (9) of the channel (6).

In step d) the edge protector (1) is held in position for sufficient time for the adhesive applied to the sides (8, 9) of the channel (6) to form a bond.

A machine for forming an edge protector (1) in one embodiment is indicated by arrow (12) in the schematic side view shown in FIG. 3.

The channel former, in the form of a router (13), is used to cut a V-shape channel through the interior liner (3) and core (2) of a vertically fluted double face corrugated panel (7).

An adhesive applicator, in the form of a wheel (10), is configured to apply droplets of adhesive against the sides (8, 9) of the V-shaped channel (6). Adhesive is coated onto grooves (11) around the rim of the wheel (10) as it rotates through an adhesive bath (22).

Typically more than one edge protector is formed from a panel (7). In such cases a cutter, in the form of a saw (14), is used to cut the panel to the required lengths.

The edge protector is then folded by the action of an angle former, generally indicated by arrow (15), which pushes the strip of panel (7) into a receptacle (16) configured such that the combined action of the angle former (15) and the receptacle (16) folds the cut panel (7) so as to close the channel (6) and hold it closed.

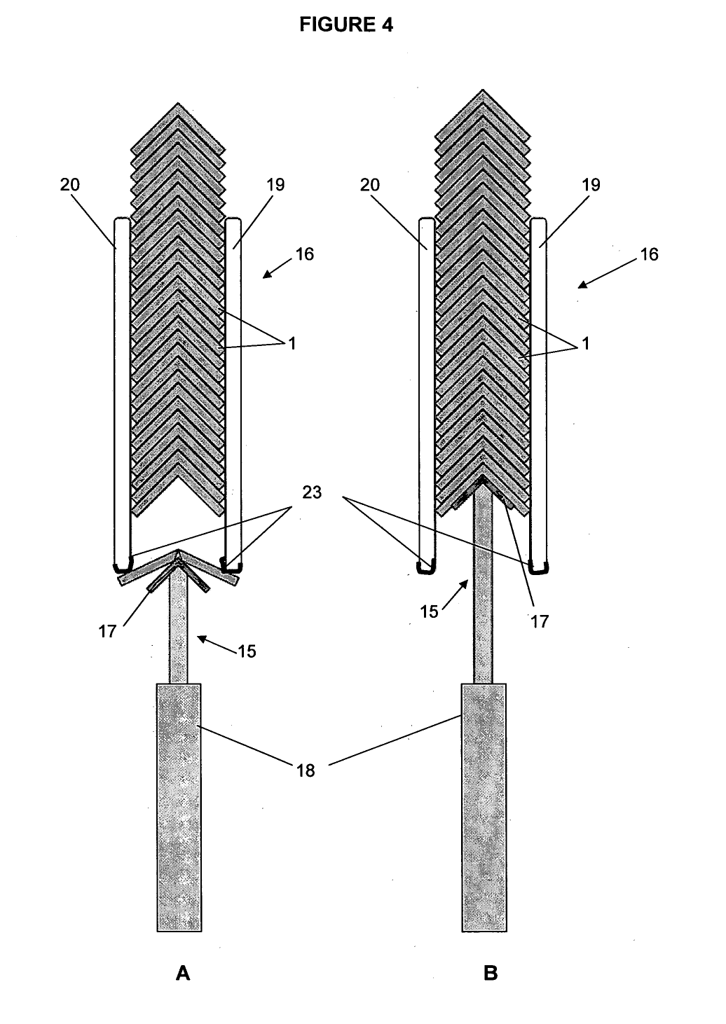

The angle former (15) includes a forming surface (17) configured to substantially the same shape as the desired shape of the finished edge protector (1), as indicated in FIG. 4.

The angle former (15) includes a hydraulic ram (18) connected in the vicinity of each end of the forming surface (17), the hydraulic ram (18) being activated to push the forming surface (17) against the edge protector and into the receptacle as indicated in FIG. 4.

The receptacle (16) includes a pair of members in the form of rigid opposed planar sheets whose inner faces form gripping surfaces (19, 20). The gripping surfaces (19, 20) are aligned substantially parallel to one another and have roughened surfaces.

The edges of the planar sheets of the receptacle which are oriented toward the angle former are slightly rounded to avoid damage to the exterior liner of the edge protector, and include a gripping surface in the form of a textured rubber layer (23).

The separation between the gripping surfaces (19, 20) is set by an adjustable spacer (22) in the form of a bolt and locking nuts connecting the two members. The separation is adjusted such that when the edge protector (1) is inserted between the gripping surfaces (19, 20) by the action of the angle former (15), the edge protector is held in shape, with the channel closed, by the friction exerted between the gripping surfaces (19, 20) and the outer edges of the edge protector.

In this manner, a stack of edge protectors is formed within the receptacle (16) as indicated in FIG. 4. The addition of each subsequent newly formed edge protector to the receptacle (16) pushes the edge protectors already in the stack along the gripping surfaces (19, 20) of the receptacle. The length of the gripping surfaces (19, 20) of the receptacle (16) is such that the time taken by an edge protector to move through the receptacle (16) is sufficient for the adhesive on the sides of the channel to form a bond.

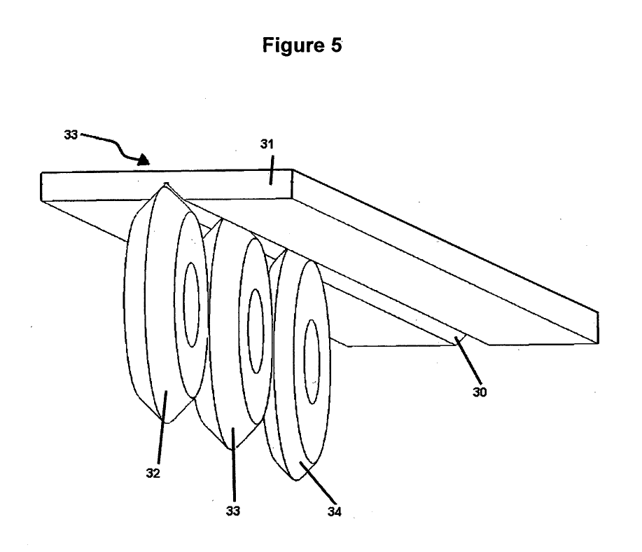

FIG. 5 illustrates an alternate method by which a channel (30) can be formed in a board (31) as part of the process of forming the board (31) into a corner protector.

In this embodiment, a thin cut is made (not shown) with a blade having a thickness in the order of 0.2 mm. If the board (31) is 10 mm thick, then it is envisaged that the depth of the cut would be in the order of 5 to 7.5 mm.

After cutting the board (31), a wheel (32) is pushed along the cut.

The wheel (32) is made of a plastics material either UHMWPE or Teflon. The outer circumference of the wheel (32) is substantially wedge shaped so as to form a V shaped profile (as generally indicated by arrow 33) in the board (31).

It is thought that the effect of pushing the wheel (32) along the length of the cut in the board (31) would cause the cut to deform into a V shaped channel. Because of the natural resistance of the paper board (31), it is envisaged that the full depth desired of the channel (30) will not be fully realised. Thus, in preferred embodiments a second wheel (33) having a similarly shaped outer circumference will be pushed along the channel (30) after the wheel (32).

It is also envisaged that in preferred embodiments a third wheel (34) (again of similar shape to the other two wheels (32) and (33)) is pushed along the channel (30). However, the wheel (34) is a glue applicator—having been dipped into a trough (not shown) of adhesive prior to be pushed along the channel. Thus, adhesive (not shown) on the outer circumference of the wedge part of the wheel (34) is effectively deposited along the inner surfaces of the channel (30) as a consequence of movement of the wheel (34).

It is envisaged that after the application of the glue from the applicator wheel (34), the corner board would be formed in substantially the same manner as described previously in the specification.

Aspects of the present invention have been described by way of example only and it should be appreciated that modifications and additions may be made thereto without departing from the scope of the appended claims.

1.-23. (canceled)

24. A method of forming an edge protector from a panel, including the steps of
a) forming a channel In the panel;
b) applying adhesive into the channel;
c) folding the panel to close the channel; and
d) holding the panel within a receptacle until the adhesive has formed a bond within the channel.

25. A method as claimed in claim 24 including the further step of e) cutting the panel to length prior to folding.

26. A method as claimed in claim 24, wherein the panel is formed from double faced corrugated board,

27. A method as claimed in claim 26 wherein the board is vertically fluted.

28. A method as claimed in claim 24, wherein the channel is configured with a V shaped section.

29. A method as claimed in claim 24, wherein the formation of the channel is started by cutting a slit in the panel.

30. A method as claimed in claim 29 wherein the formation of the channel is completed by deforming the panel in the vicinity of the cut.

31. A method as claimed in claim 30 wherein the deformation of the channel is caused by a wheel configured with a wedge shape on its outer circumference.

32. A method as claimed in claim 24, wherein the adhesive is applied to the channel with an applicator wheel.

33. A method as claimed in claim 24, wherein the adhesive is applied to the channel in discrete amounts.

34. An edge protector made in accordance with the method as claimed in claim 24.

35. A machine for producing an edge protector from a panel, including:
a channel former configured to form a channel in the panel;
an applicator configured to apply adhesive into the channel;
a folding mechanism; and
a receptacle;
wherein the folding mechanism is configured to fold the panel so as to close the channel and form the edge protector, and a receptacle is configured to hold the edge protector in shape until the adhesive forms a bond within the channel.

36. A machine as claimed in claim 35 which includes a cutting mechanism configured to cut at least part of the channel within the panel.

37. A machine as claimed in claim 36 which includes a wheel configured to deform the panel in the vicinity of the cut into the desired channel.

38. A machine as claimed in claimed in claim 35, wherein the adhesive applicator is in the form of a wheel.

39. A machine as claimed in claim 38, wherein the adhesive applicator wheel includes one or more grooves on its rim.

40. A machine as claimed in claim 35, wherein the folding mechanism includes a forming surface.

41. A machine as claimed in claim 35, wherein the receptacle includes at least two members, each member having an inner face, an outer face and an edge therebetween, wherein the two members are positioned such that the inner face of a first member is substantially parallel to and opposite the inner face of a second member, and at least two adjustable spacers configured to adjust the separation between the opposing members, wherein the positioning of the spacers enables a clear pathway between the inner faces of the first and second members, and a substantial part of the inner faces of the first and second members form a gripping surface.

42. An edge protector made from the machine as claimed in claim 35.
